(19) United States
(12) Patent Application Publication
(10) Pub. No.: US 2004/0157965 A1
(43) Pub. Date: Aug. 12, 2004

(54) Carbon black pigmented yarn with improved physical properties

(76) Inventors: John D Pace, Abbeville, SC (US); Scott E Osborn, Pensacola, FL (US)

Correspondence Address: Craig M Lundell, Howrey Simon Arnold & White, 750 Bering, Houston, TX, 77057-2198, US

(21) Appl. No.: 10/475,628

(22) PCT Filed: Apr. 22, 2002
(86) PCT No.: PCT/US02/12657

(51) Int. Cl. C08K 5/34; C08K 3/04

(52) U.S. Cl. 524/88; 524/495

(57) ABSTRACT

A fiber and process of forming the fiber containing nylon 6,6, carbon black, and copper phthalocyanine colorant, which may be spun into a yarn with improved physical properties is provided. The carbon black concentration may be up to 2% of the fiber by weight, and the concentration of copper phthalocyanine colorant may be up to 4% of the fiber by weight. The fiber may optionally contain a copolymer.

### 1. FIELD OF THE INVENTION

The present invention is generally directed to pigmented polyamide fibers and processes for making them. More particularly, the present invention is directed to a nylon 6,6 fiber containing carbon black.

### 2. BACKGROUND

Nylon fiber is widely used in the manufacture of textile materials, carpet yarn, and apparel products. For aesthetic and utilitarian purposes, nylon fiber may be colored using a variety of techniques. One method is to include a pigment in the polymer melt from which the nylon fiber is spun. Molten polymer is extruded through capillaries in a spinneret. As the molten polymer solidifies, fibers are formed. If black fibers are desired, carbon black may be used in the color concentrate.

As the amount of carbon black is increased in the polyamide fibers, the physical properties can significantly change such as the breaking strength. This may also cause the spinning characteristics of the yarn to change. One skilled in the art may conclude that this is caused by the color concentrate lowering the RV of the yarn and causing nucleation in the yarn. Inadequate carbon black particle distribution may be the source of the problems especially when the polyamide is nylon 6,6.

Higher elongation and lower breaking strength are characteristics of yarn that is nucleated and are typically present in nylon 6,6 yarn with a high carbon black concentration. One of skill in the art will appreciate that if a small percentage of the polymer segments are caused to crystallize before the rest of the polymer, it will keep the rest of the polymer from being able to move around and crystallize. This will increase the amount of amorphous material, thus raising the elongation and lowering the strength. This does not tend to happen with nylon 6 and polyester because nylon 6,6 crystallizes approximately 10 times faster than nylon 6 and approximately 100 times faster than polyester.

Others have tried to overcome the nucleation problem using improved filtration to remove aggregated carbon black in pigment concentrates, lower carbon black levels, and using polyester (PET) or nylon 6 instead of nylon 6,6.

The use of copper phtalocyanine pigment and carbon black as a pigment for polyamide molding compositions is disclosed in U.S. Pat. No. 4,518,728. The toughness of the molding compositions was increased. Typically in a molded composition, the polymer has low orientation. In the case of a fiber to be used in yarns the polymer is more highly oriented. Because molded parts have low orientation and fibers have high orientation, materials that improve the properties of one may not improve the properties of the other. If this orientation in fibers is disrupted by carbon black nucleation, the yarn spun from the fibers may have less desirable physical properties such as breaking strength. None of the nylon 6,6 fibers with a high concentration of carbon black to date exhibit good spinning characteristics when spun into yarn and produce a yarn with excellent physical properties such as elongation and tenacity.

Thus, there exists a need for a nylon 6,6 fiber composition with a high carbon black concentration which can be spun into a yarn with improved physical properties.

### SUMMARY OF THE INVENTION

The present invention is generally directed to a fiber containing nylon 6,6, carbon black, and copper phthalocyanine colorant. The carbon black concentration may be up to about 2% of the fiber by weight, and the concentration of copper phthalocyanine colorant may be up to 4% of the fiber by weight. This fiber exhibits improved spinning characteristics when making yarn such as an increase in drawforce, an increase in tenacity, and a decrease in filament breaks. The yarn also has improved physical properties over other yarns with high carbon black concentrations. The present invention may additionally contain a copolymer. The copolymer is selected from the group including nylon 6,6 with 2% nylon 6, nylon 6,I, nylon 6, sulfonated IA, nylon 6,9, nylon 6,10, nylon 6,T, nylon 6/12, nylon 11, nylon 12 and mixtures thereof. One of ordinary skill in the art should know how to make or commercially obtain these nylon copolymers which are commercially available from numerous sources including Solutia Inc. of St. Louis, Mo.

The present invention is also directed to the processes of forming the fibers described above.

### DESCRIPTION OF ILLUSTRATIVE EMBODIMENTS

The following terms and phrases are used herein and are intended to have the following meanings:

“fiber” is any continuous filament or staple form of a polyamide polymer which may be spun, knitted, woven, pressed, tufted and otherwise formed in the manufacturing of carpets or other textile materials;

“yarn” is any spun material made from natural or synthetic fibers or mixtures or blend thereof.

“copper phthalocyanine colorant” is any of the polymorphic crystalline forms of copper phthalocyanine and blends of such forms. A complete description of copper phthalocyanine colorants may be found in Analytical Chemistry of Synthetic Dyes, editor K. Van Kataraman, J. Wiley & Sons (1977), the entire contents of which are incorporated herein by reference.

One aspect of the present invention is generally directed to a nylon 6,6 fiber with carbon black, and copper phthalocyanine colorant.

After determining that yarn made from nylon 6,6 fibers with a high carbon black concentration was having spinning problems, microscopy testing of carbon black particle size and dispersion in the fibers and pigment concentrate was performed. A longitudinal view of the yarn showed that there were agglomerates of carbon black along the threadline. Differential Scanning Calorimetry (DSC) recrystallization tests, relative viscosity (RV) results, and tensile properties indicated that the carbon black was nucleating nylon 6,6 and causing it to crystallize too quickly.

One of skill in the art will appreciate that polymer with a higher recrystallization temperature will crystallize faster and higher up the spinning chimney. Also, the lower RV polymer will crystallize slower and help counteract the crystallization caused by the carbon black.

Possible solutions to the spinning problem were to lower the RV, modify the process conditions, or make changes to the polymer. The RV is lowered so that the polymer crystallizes slower and helps counteract the problems of carbon black. Faster crystallization may also be counteracted by using higher melt temperatures and slower quenching. Polymer changes to slow down the crystallization such as using more nylon 6 may result in higher shrinkage. All of the above options interact together such that changes to one may cause other undesirable problems to develop.

When copper phthalocyanine colorant is added to the nylon 6,6 with a high carbon black concentration of up to 2% by weight, no appreciable nucleation occurs. There is also excellent carbon black dispersion, lower elongation, and higher breaking strength when the fiber is spun into a yarn. The amount of copper phthalocyanine colorant in the final fiber composition may be between 0.0001% and 4% by weight. The preferred amount of copper phthalocyanine colorant is such that the fiber composition has a final weight percent of 0.005 to 0.2 of copper phthalocyanine colorant.

In an additional embodiment of the present invention, a copolymer is formed by adding nylon 6 to the nylon 6,6 in addition to the carbon black and copper phthalocyanine colorant to form a pigmented polymer. The copolymer may comprise nylon 6,6 in an amount of about 95.0 to about 99.5 wt %, preferrably about 96 to about 99 wt %, and more preferably about 97 to about 98 wt % by weight of the copolymer. The remainder of copolymer may contain nylon 6 in an amount of about 0.5 to about 5.0 wt %, preferably about 1 to about 4 wt %, and more preferably about 2 to about 3 wt % by weight of the copolymer. The pigmented polymer may contain up about 2 wt % of carbon black (preferably about 0.5 to about 2.0 wt %) and up to 4 wt % copper phthalocyanine colorant (preferably about 0.005 to about 0.3 wt %) by weight of the pigmented polymer. If the colorant and pigment are added in the form of a concentrate, then the concentrate is present in an amount of about 1 to about 10 wt %, preferably about 2 to about 7 wt %, and more preferably about 3 to about 5 wt %, by weight of the pigmented polymer, with the remainder being made of the copolymer. The concentrate may contain the desired amounts of pigment and colorant in order to achieve the amounts specified herein with regard to the resulting pigmented polymer. Preferably, the polymer in the concentrate is nylon 6. With the addition of the concentrate, physical properties of the resulting fibers are improved. The yarn also has a softer, slicker feel. There is a reduction of the drawforce (Dynafil) of between 5 and 15 cN, an increase in tenacity of 0.4 to 0.8 gram/denier, and a reduction in filament breaks in the quench chamber of 50% to 75%. Typical partially oriented yarns (POY) have a drawforce of 85 to 90 cN, elongation percent of approximately 70% and a tenacity of approximately 4.5 grams/denier.

In a preferred embodiment, the yarns of the present invention may be made by using the pigmented polymer and then producing the yarns by standard techniques. The pigment and colorant may be added in neat form directly to the copolymer, or by forming one or more pigmented concentrates containing the pigment and/or colorant compounded with a polymer, preferably nylon 6, and then letting the concentrate down into the copolymer. For example, a pigmented concentrate may be formed by mixing the carbon black with the copper phthalocyanine blue in a desired ratio and then compounding the mixture with nylon 6. The pigmented concentrate(s) may then be blended with a suitable copolymer, such as nylon 6,6 polymerized with nylon 6, and subsequently melt spinning the blended pigmented polymer into fibers and/or yarns.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its is practice. However, those of skill in the art should, in light of the present disclosure, appreciate that many changes can be made in the specific embodiments which are disclosed and still obtain a like or similar result without departing from the spirit and scope of the invention.

General Information Relevant to the Examples

The following terms are used in describing the following examples:

“1^{st} and 2^{nd} REXC” are recrystallization temperatures

“DEN” is the denier

“RV” is relative viscosity

“BS” is the breaking strength in grams/denier

“EL” is the elongation

“TEN” is the tenacity in gram-force/denier

“MODSTF” is modulus stiffness at 1.0% elongation

“LOD/X” is load in grams at 57.0% elongation

“ELG/GM” is elongation at 110.0 gram load

All tests were performed on a Perkin Elmer DSC and an Instron Tensile Tester.

### EXAMPLE 1

A nonpigmented yarn is compared to three black pigmented yarns. The following Tables 1 and 2 contain the physical property test results of the three mass pigmented black nylon 6,6 yarns and the nonpigmented nylon 6,6 control. Each of the samples is a 95 denier/34 filament partially oriented yarn. Samples 1-3 are spun at 4,500 meters per minute and Sample 4 is spun at 4,800 meters per minute. Sample 1 is 97.975% nylon 6,6, 2% nylon 6 and 0.0125% TiO₂ for brightness and has a RV of 41, 47.5 amine end groups and 9 parts per million Mn. Sample 2 is pigmented by adding about 4% PAF-50, a commercial carbon black concentrate from Magenta Master Fibers to the yarn used in Sample 1. Samples 3 and 4 are formed by adding a concentrate to the yarn used in Sample 1. The concentrate is formed by compounding 20% carbon black with 0.4% copper phthalocyanine blue and 79.6% of nylon 6. The carbon black and copper phthalocyanine are compounded to form a concentrate before they are blended with the copolymer. About 4% of this concentrate is added to the copolymer used in Sample 1 to form Samples 3 and 4.

TABLE 1

| | | | wt % | | | | |
|---|---|---|---|---|---|---|---|
| | | | Copper | 1^{st} | 2^{nd} | 1^{st} | |
| | | wt % | Phthal- | melt | melt | REXC | 2^{nd} REXC |
| | | Carbon | ocyanine | temp | temp | temp | temp |
| Sample | RV | Black | blue | ° C. | ° C. | ° C. | ° C. |
| 1 | 44.10 | 0 | 0 | 254.2 | 256.9 | 225.0 | 223.3 |
| 2 | 43.49 | 1.58 | 0 | 254.8 | 256.3 | 230.0 | 228.0 |
| 3 | 43.78 | 0.75 | 0.016 | 255.4 | 257.0 | 225.0 | 222.6 |
| 4 | 43.42 | 0.66 | 0.016 | 253.8 | 256.6 | 225.6 | 223.3 |

TABLE 2

| Sample | DEN | BS | EL | TEN | MODST | ELG/GM |
|---|---|---|---|---|---|---|
| 1 | 98.69 | 443.67 | 38.5 | 4.50 | 38.79 | 16.69 |
| 2 | 99.24 | 177.93 | 60.73 | 1.79 | 27.90 | 33.64 |
| 3 | 95.88 | 207.54 | 50.17 | 2.17 | 23.98 | 23.51 |
| 4 | 98.86 | 200.68 | 45.78 | 2.03 | 29.70 | 20.68 |

As can be seen from the test results, Samples 3 and 4 which are made according to the present invention, have improved breaking strength, elongation and tenacity as compared to the black pigmented yarn without copper phthalocyanine blue.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such substitutes and modifications apparent to those skilled in the art are deemed to be within the spirit, scope and concept of the invention as defined by the appended claims.

1. A black pigmented fiber comprising: (1) nylon 6,6; (2) up to about 2 wt % carbon black; (3) up to about 4 wt % copper phthalocyanine colorant.

2. The fiber of claim 1 wherein the concentration of carbon black by weight is about 0.02% to about 2%.

3. The fiber of claim 1 wherein the concentration of the copper phthalocyanine colorant by weight is about 0.0001% to about 4%.

4. The fiber of claim 1 additionally comprising a copolymer.

5. The fiber of claim 4 wherein the copolymer is nylon 6,6 with 2% nylon 6.

6. The fiber of claim 4 wherein the concentration of copolymer by weight is about 0.5% to about 5%.

7. The fiber of claim 1 or claim 4 wherein the fiber is spun into a yarn.

8. A process for forming a black pigmented fiber comprising combining nylon 6,6, up to about 2% by weight carbon black, and up to about 4% by weight copper phthalocyanine colorant; and extruding the mixture to form a fiber.

9. The process of claim 8 wherein the concentration of carbon black by weight is about 0.02% to about 2%.

10. The process of claim 8 wherein the concentration of copper phthalocyane colorant by weight is about 0.0001% to about 4%.

11. The process of claim 8 further comprising the addition of a copolymer.

12. The fiber of claim 11 wherein the copolymer is nylon 6,6 with 2% nylon 6.

13. The process of claim 11 wherein the copolymer concentration by weight is about 0.5% to 5%.

14. The process of claim 8 or claim 11 wherein the fiber is spun into a yarn.
